(19) United States
(12) Patent Application Publication
(10) Pub. No.: US 2006/0281475 A1
(43) Pub. Date: Dec. 14, 2006

(54) METHOD FOR A REMOTE LISTEN-IN OPERATION ACTIVATED BY A SHORT MESSAGE

(76) Inventor: Chia-Hua Hsu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/422,882

(22) Filed: Jun. 8, 2006

(30) Foreign Application Priority Data
Jun. 8, 2005 (TW) 094118908

(51) Int. Cl. H04Q 7/20

(52) U.S. Cl. 455/466

(57) ABSTRACT

A method for a remote listen-in operation using short messages includes sending a short message to a mobile phone, the short message including a remote listen-in command and a phone number. When the mobile phone receives and parses the short message, the mobile phone automatically dials the phone number to make a phone call.

### BACKGROUND OF THE INVENTION

1. Field of the Invention

The present invention relates to a method for a remote listen-in operation, and more particularly, to a method for a remote listen-in operation activated by a short message.

2. Description of the Prior Art

With the advanced technology, mobile phones provide more functions, such as taking digital pictures, receiving radio broadcasting or playing music, to meet user requirements. However, in addition to these advanced functions, the convenience and some problems when using mobile phones should be considered.

For instance, when a user forgets where they put their mobile phone, the user might dial the phone number of the lost mobile phone causing it to ring, so that they could follow the ringing to locate the mobile phone. But, when the mobile phone is far away from the user or has been found by someone else, the user cannot easily use the same technique. The user would need to communicate with the person who picked up the mobile phone or anyone near the mobile phone in order to get the phone back.

However, if the person who has the mobile phone intends to keep it (i.e. maybe it was stolen) or no one is located near the lost mobile phone, the user has no way to find the phone.

### SUMMARY OF THE INVENTION

It is therefore a primary objective of the claimed invention to provide a method for a remote listen-in operation using short messages to solve the above-mentioned problem.

The claimed invention discloses a method of a remote listen-in operation activated by a short message. The method comprises sending a short message comprising a listen-in command and a phone number to a mobile phone, and the mobile phone receiving and parsing the short message and automatically dialing the phone number.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a first mobile phone communicating with a second mobile phone via a wireless communication network according to the present invention.

FIG. 2 shows a structure of the second mobile phone of FIG. 1.

FIG. 3 is a flowchart of the remote listen-in method according to the present invention.

### DETAILED DESCRIPTION

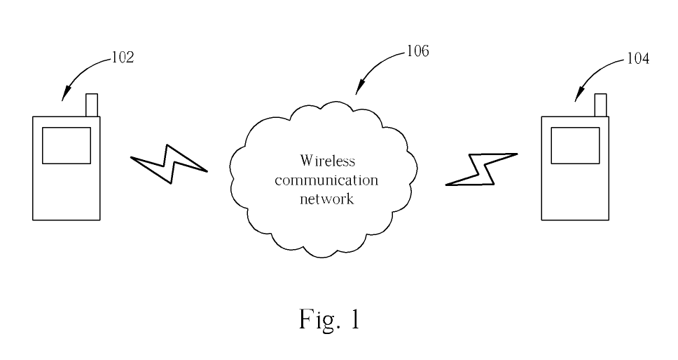

Please refer to FIG. 1, which is a diagram of a first mobile phone 102 communicating with a second mobile phone 104 via a wireless communication network 106 according to the present invention. The wireless communication network 106 establishes communication between the first mobile phone 102 and the second mobile phone. The second mobile phone 104 has the listen-in function according to the present invention. Mobile phones nowadays not only make calls for communication, but also can access voice messages in the wireless communication network 106. The wireless communication network 106 also provides transmission services, such as a short message service (SMS). With the wireless communication network 106, a user can send a short message composed of text to another user's mobile phone wirelessly. Then, the mobile phone receiving the wireless signal can display the text included in the short message by decoding the wireless signal. In addition to textual short messages, the present invention also can send a command to a mobile phone via SMS to instruct the mobile phone receiving the short message to react according to the command.

Suppose that the user loses the second mobile phone 104. In such a situation, the user usually dials the number of the second mobile phone 104 to cause it to ring. Then, the user can follow the ringing to locate the second mobile phone 104. However, if the second mobile phone 104 is out of the hearing range of the user, the user cannot locate it this way. Therefore, the present invention provides a method of using another mobile phone (the first mobile phone 102) to send a listen-in message to the second mobile phone 104 with the listen-in function according to the present invention. In response, the second mobile phone 104 makes a call to the first mobile phone 102 responsive to the listen-in message so that the user can remotely listen in (e.g. monitor or eavesdrop) to the second mobile phone 104 via the first mobile phone 102 to locate the second mobile phone 104.

In the present invention, the listen-in message comprises a listen-in code, a listen-in command, and a phone number. The listen-in message is transmitted via SMS provided by the wireless communication network 106. For example, when the user sends a listen-in message to the second mobile phone 104 by the first mobile phone 102, the listen-in message is sent to the second mobile phone 104 via the wireless communication network 106. Since the listen-in message is a textual short message with a special format, such as “listen-in code”+“listen-in command”+“phone number” (i.e. 1234LISTEN1234567890), when the second mobile phone 104 receives the listen-in message, the second mobile phone 104 parses the information in the short message to extract the command “LISTEN” indicating a listen-in message. Then, the second mobile phone 104 checks whether the listen-in code is correct. If the listen-in code is correct, the second mobile phone 104 automatically dials the phone number “1234567890” included in the listen-in message. If the listen-in code is incorrect, the second mobile phone 104 sends an error message to the first mobile phone 102 instead of dialing the phone number included in the listen-in message. The phone number included in the listen-in message, for example, can be the phone number of the first mobile phone 102. After the second mobile phone 104 dials the phone number included in the listen-in message, the user can communicate with the second mobile phone 104 via the first mobile phone 102. After the call is established, the user can listen to background sound near the second mobile phone 104 so as to determine the position of the second mobile phone. If the user wants to end the listen-in operation, the first mobile phone 102 is just disconnected. In addition, the phone number included in the listen-in message can be a phone number of another mobile phone different from the first mobile phone 102 or a landline telephone. Similarly, when the user is finished listening, the call is just disconnected.

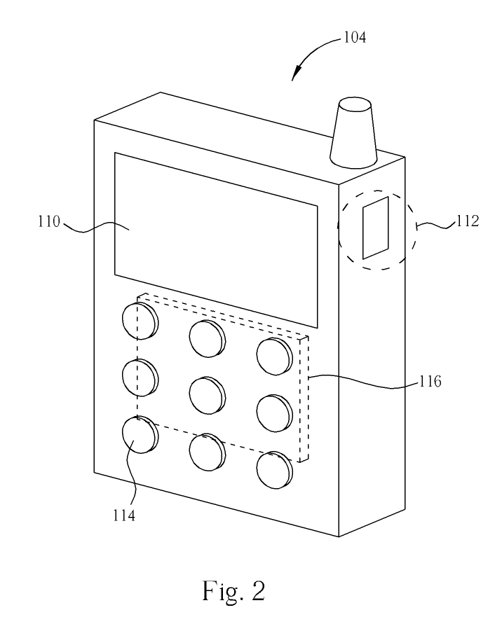

Please refer to FIG. 2, which shows a structure of the second mobile phone 104 according to the present invention. The second mobile phone 104 comprises a screen 110, a speaker 112, a plurality of buttons 114, and a wireless communication system 116 comprising software, firmware, and/or hardware. The wireless communication system 116 executes the method of the present invention by using software, firmware, or both, in cooperation with hardware. Additionally, if another person finds the second mobile phone 104 and intends to keep it, the present invention provides another function so that the person is not aware that the user is listening in to the second mobile phone 104. Generally, when receiving a short message, a speaker of the mobile phone emits sound to inform the user of the incoming message and the screen of the mobile phone displays the information of the incoming message. These alert functions of the prior art lead to difficulty in any listen-in or eavesdropping operation. Therefore, the present invention further provides a method to solve this problem. That is, after receiving the listen-in message, the second mobile phone 104 generates a command to disable the alert functions; neither ringing is made by the speaker 112 nor indication of the short message is displayed on the screen 110. Additionally, in the prior art, when the second mobile phone 104 automatically dials the phone number included in the listen-in message, a calling-out or communication message is displayed on the screen. Thus, the listen-in message of the present invention prevents the second mobile phone 104 from emitting sound and from displaying the calling-out or communication message. In a word, there are no short message received alert and dialing alert on the second mobile phone 104 when the second mobile phone 104 receives the short message and automatically dials the phone number.

However, even if the person who has the lost phone is not aware of being monitored, the second mobile phone 104 would still store the received listen-in message and log the subsequently called phone number. Therefore, according to the information stored in the second mobile phone 104, the person could discover that he or she is being monitored. In this case, after receiving and parsing the listen-in message, the second mobile phone 104 deletes the listen-in message and the call out record. In addition, during the listen-in operation, the person might choose to operate the second mobile phone 104 and thereby discover that he or she is being monitored. In order to solve this problem, the method of the present invention further comprises automatically disconnecting the listen-in call when one of the buttons 114 is pushed.

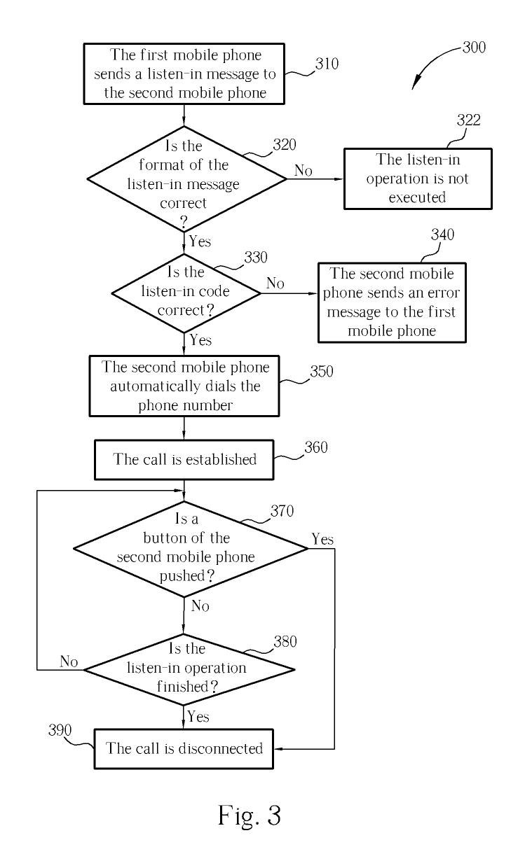

In order to shed light on how to operate a mobile phone to execute the remote listen-in operation, please refer to FIG. 3, which is a flowchart of a method 300 according to the present invention. In step 310, the first mobile phone 102 sends a listen-in message to the second mobile phone 104, including a listen-in code, a listen-in command, and a phone number. After receiving the listen-in message, the second mobile phone 104 checks whether the format of the listen-in message and the listen-in code are correct, respectively in steps 320 and 330. If the format is incorrect, the mobile phone 104 does not regard the message as the listen-in message, and thereby the listen-in operation of the present invention is not executed in step 322. If the listen-in code is incorrect, the listen-in message is invalid. The second mobile phone 104 sends an error message to the first mobile phone 102 instead of executing the listen-in operation, as shown in step 340. If the format and the listen-in code are both correct, in step 350, the second mobile phone 104 automatically dials the phone number included in the listen-in message. Next, in step 360, the call is established to start the remote listen-in operation. As shown in step 370, after executing the listen-in operation, if anyone operates the second mobile phone 104, for example, by pushing one of the buttons 114 of the second mobile phone 104, the second mobile phone 104 automatically disconnects the monitoring call. Otherwise, the listen-in operation continues until the user finishes the listen-in operation in step 380. In step 390, the call is disconnected to finish the listen-in operation. Steps of the method 300 are not limited to the above, and the sequence of the steps can also be changed, as long as the key features are realized. For instance, the method 300 might further comprise deleting the listen-in message in the second mobile phone 104, and deleting a call-out log record in the second mobile phone 104 after step 350.

In conclusion, the present invention provides a method for a remote listen-in operation activated by a short message. The present invention takes advantage of the SMS provided by the wireless communication network 106 to accomplish the remote listen-in operation by using software, firmware, or both, in cooperation with hardware. Therefore, a user can more easily locate a lost mobile phone.

Compared to the prior art, the present invention utilizes a short message to cause the lost mobile phone to make a call to the user, such that the user can find the lost mobile phone. In the prior art, if the mobile phone is out of earshot, it is very difficult to find by simply calling it and listening for ringing.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a remote listen-in operation activated by a short message, the method comprising:
sending a short message to a mobile phone, the short message comprising a listen-in command and a phone number; and
the mobile phone receiving and parsing the short message and automatically dialing the phone number.

2. The method of claim 1, wherein the short message further comprises a listen-in code.

3. The method of claim 2 further comprising the mobile phone checking whether the listen-in code is correct.

4. The method of claim 3 further comprising the mobile phone automatically dialing the phone number if the listen-in code is correct.

5. The method of claim 3 further comprising the mobile phone sending an error message if the listen-in code is incorrect.

6. The method of claim 1 further comprising the mobile phone deleting the short message after receiving and parsing the short message.

7. The method of claim 1, wherein the mobile phone automatically dialing the phone number comprises the mobile phone dialing the phone number without dialing alert on the mobile phone.

8. The method of claim 1 further comprising when the mobile phone receives the short message, the mobile phone generating a command to prevent the mobile phone from short message received alert.

9. The method of claim 1 further comprising the mobile phone deleting a record of dialing the phone number.

10. The method of claim 1 further comprising the mobile phone automatically disconnecting connection to a phone assigned to the phone number when at least one of buttons of the mobile phone is pushed.

11. The method of claim 1 further comprising:
establishing a call to a phone assigned to the phone number for executing the listen-in operation; and
disconnecting the call for finishing the listen-in operation.
